(19) United States
(12) Patent Application Publication
(10) Pub. No.: US 2007/0109306 A1
(43) Pub. Date: May 17, 2007

(54) Transparency optimization method and system

(75) Inventors: Raymond Edward Clark, Georgetown, KY (US); Robert Lawrence Cook, Lexington, KY (US); Ning Ren, Lexington, KY (US); Martin Geofrey Rivers, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/274,027

(22) Filed: Nov. 15, 2005

(51) Int. Cl. G06T 1/00

(52) U.S. Cl. 345/501

(57) ABSTRACT

A method includes monitoring one or more print commands received by a print driver to identify a suspect command. The suspect command is indicative of a repetitive rendering process. The suspect command is modified to include a set flag proximate a beginning portion of the suspect command.

### TECHNICAL FIELD

This disclosure relates to printing devices and, more particularly, to methods and systems for rendering transparent objects that are provided to printing devices.

### BACKGROUND

Printing devices may receive print jobs from various sources, such as computers directly attached to the printing device via a printer cable and/or computers indirectly attached to the printing device via a computer network.

Print jobs may define a plurality of objects to be rendered on the various pages of the print job. Often, individual objects will overlap with other objects on the same page. Further, the overlapping object may be made partially transparent so that the overlapped object is viewable beneath the overlapping object. For example, a first object (e.g., a text-based title) may overlap a second object (e.g., a photographic image). This text-based title may be made partially transparent so that the photographic image is still visible “through” the text-based title. When rendering a transparent object (i.e., the text-based title), an image mask (i.e., smaller than the overlapping object) may be repeatedly applied to the overlapping object to render the overlapping object transparent. Unfortunately, this process may result in the overlapping object being rendered each time that the image mask is applied, which may reduce the performance of the printing device.

### SUMMARY OF THE DISCLOSURE

In one exemplary implementation, a method includes monitoring one or more print commands received by a print driver to identify a suspect command. The suspect command is indicative of a repetitive rendering process. The suspect command is modified to include a set flag proximate a beginning portion of the suspect command.

One or more of the following features may be included. The suspect command may be modified to include a reset flag proximate an ending portion of the suspect command. The repetitive rendering process may be configured to render a first object on top of a second object. The first object may be a transparent object.

The suspect command may include the first object and an image mask. The image mask may be indicative of a level of transparency of the first object. The image mask may be a checkerboard mask. The image mask may have a defined x-axis dimension and a defined y-axis dimension. The first object may have a defined x-axis dimension and a defined y-axis dimension. At least one of the x-axis and y-axis dimensions of the image mask may be less than at least one of the x-axis and y-axis dimensions of the first object.

The repetitive rendering process may be further configured to apply the image mask to a plurality of unique portions of the first object. The first object may be rendered prior to each application of the image mask. The suspect command may be a GDI (graphical device interface) escape sequence.

In another exemplary implementation, a computer program product residing on a computer readable medium has a plurality of instructions stored on it. When executed by a processor, the instructions cause the processor to monitor one or more print commands received by a print driver to identify a suspect command. The suspect command is indicative of a repetitive rendering process. The suspect command is modified to include a set flag proximate a beginning portion of the suspect command.

One or more of the following features may be included. The suspect command may be modified to include a reset flag proximate an ending portion of the suspect command. The repetitive rendering process may be configured to render a first object on top of a second object. The first object may be a transparent object.

The suspect command may include the first object and an image mask. The image mask may be indicative of a level of transparency of the first object. The image mask may be a checkerboard mask. The image mask may have a defined x-axis dimension and a defined y-axis dimension. The first object may have a defined x-axis dimension and a defined y-axis dimension. At least one of the x-axis and y-axis dimensions of the image mask may be less than at least one of the x-axis and y-axis dimensions of the first object.

The repetitive rendering process may be further configured to apply the image mask to a plurality of unique portions of the first object. The first object may be rendered prior to each application of the image mask. The suspect command may be a GDI (graphical device interface) escape sequence.

In another exemplary implementation, a method includes monitoring one or more print commands received from a print driver to identify a suspect command. The suspect command is processed to extract an image mask and a first object. The first object is a transparent object. The first object is rendered to generate a rendered first object. The image mask is applied to at least two unique portions of the rendered first object.

One or more of the following features may be included. The suspect command may include a set flag proximate a beginning portion of the suspect command. The suspect command may include a reset flag proximate an ending portion of the suspect command.

The image mask may have a defined x-axis dimension and a defined y-axis dimension. The first object may have a defined x-axis dimension and a defined y-axis dimension. At least one of the x-axis and y-axis dimensions of the image mask may be less than at least one of the x-axis and y-axis dimensions of the first object.

The rendered first object may include a plurality of unique portions. Applying the image mask to at least two unique portions of the rendered first object may include applying the image mask to each of the plurality of unique portions of the rendered first object. The suspect command may be a GDI (graphical device interface) escape sequence.

A second object may be rendered. Rendering the first object may include rendering the first object on top of the second object. The first object may be a transparent object. The image mask may be indicative of a level of transparency of the first object. The image mask may be a checkerboard mask.

In another exemplary implementation, a computer program product residing on a computer readable medium has a plurality of instructions stored on it. When executed by a processor, the instructions cause the processor to monitor one or more print commands received from a print driver to identify a suspect command. The suspect command is processed to extract an image mask and a first object. The first object is a transparent object. The first object is rendered to generate a rendered first object. The image mask is applied to at least two unique portions of the rendered first object.

One or more of the following features may be included. The suspect command may include a set flag proximate a beginning portion of the suspect command. The suspect command may include a reset flag proximate an ending portion of the suspect command.

The image mask may have a defined x-axis dimension and a defined y-axis dimension. The first object may have a defined x-axis dimension and a defined y-axis dimension. At least one of the x-axis and y-axis dimensions of the image mask may be less than at least one of the x-axis and y-axis dimensions of the first object.

The rendered first object may include a plurality of unique portions. Applying the image mask to at least two unique portions of the rendered first object may include applying the image mask to each of the plurality of unique portions of the rendered first object. The suspect command may be a GDI (graphical device interface) escape sequence.

A second object may be rendered. Rendering the first object may include rendering the first object on top of the second object. The first object may be a transparent object. The image mask may be indicative of a level of transparency of the first object. The image mask may be a checkerboard mask.

In another exemplary implementation, a printing device is configured for monitoring one or more print commands received from a print driver to identify a suspect command. The suspect command is processed to extract an image mask and a first object. The first object is a transparent object. The first object is rendered to generate a rendered first object. The image mask is applied to at least two unique portions of the rendered first object.

One or more of the following features may be included. The suspect command may include a set flag proximate a beginning portion of the suspect command. The suspect command may include a reset flag proximate an ending portion of the suspect command.

The image mask may have a defined x-axis dimension and a defined y-axis dimension. The first object may have a defined x-axis dimension and a defined y-axis dimension. At least one of the x-axis and y-axis dimensions of the image mask may be less than at least one of the x-axis and y-axis dimensions of the first object.

The rendered first object may include a plurality of unique portions. Applying the image mask to at least two unique portions of the rendered first object may include applying the image mask to each of the plurality of unique portions of the rendered first object. The suspect command may be a GDI (graphical device interface) escape sequence.

A second object may be rendered. Rendering the first object may include rendering the first object on top of the second object. The first object may be a transparent object. The image mask may be indicative of a level of transparency of the first object. The image mask may be a checkerboard mask.

The details of one or more exemplary implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a computing device coupled to a printing device;

FIG. 2 is a diagrammatic view of the printing device of FIG. 1;

FIG. 3 is a diagrammatic view of the computing device of FIG. 1;

FIG. 4 is a diagrammatic view of a first object positioned on top of a second object;

FIGS. 5-6 are diagrammatic views of an image mask applied to the first object of FIG. 4;

FIG. 7 is a diagrammatic view of the image mask applied to the first object of FIG. 4, such that the first object is applied to the second object of FIG. 4;

FIG. 8 is a flow chart of a process executed by the computing device of FIG. 1; and

FIG. 9 is a flow chart of a process executed by the printing device of FIG. 1.

### DETAILED DESCRIPTION OF THE PREFERRED EMBODIMENTS

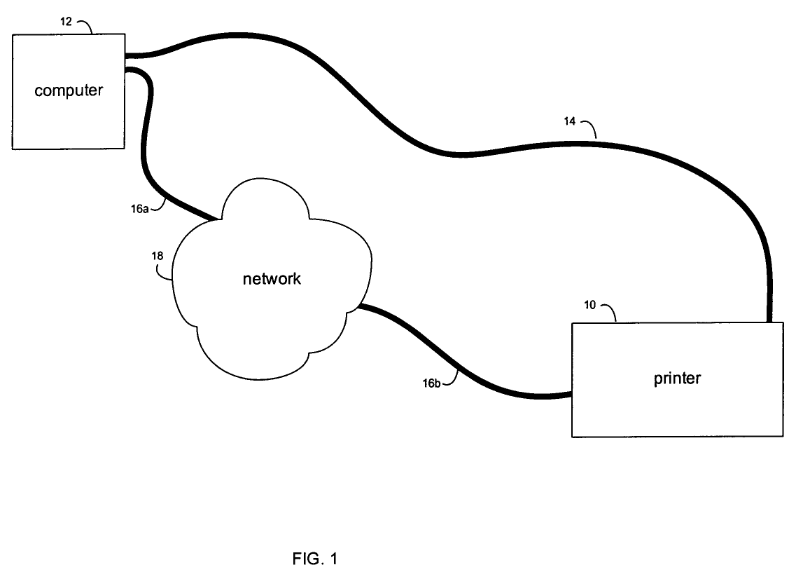

Referring to FIG. 1, there is shown a printing device 10 that may be coupled to a computing device 12 via e.g. a parallel printer cable 14, a universal serial bus cable (not shown), and/or one or more network cables 16a, 16b and computing network 18. Examples of computing network 18 include a local area network; a wide area network; an intranet, or the internet, for example

While printing device 10 is shown (in this example) to be a laser printer, other configurations are possible. For example, printing device 10 may be an inkjet printer, a photocopier, and/or an all-in-one unit.

Printing device 10 may be a device that accepts text and graphic information from a computing device (e.g., computing device 12) and transfers the information to various forms of media (e.g., paper, cardstock, transparency sheets, etc.).

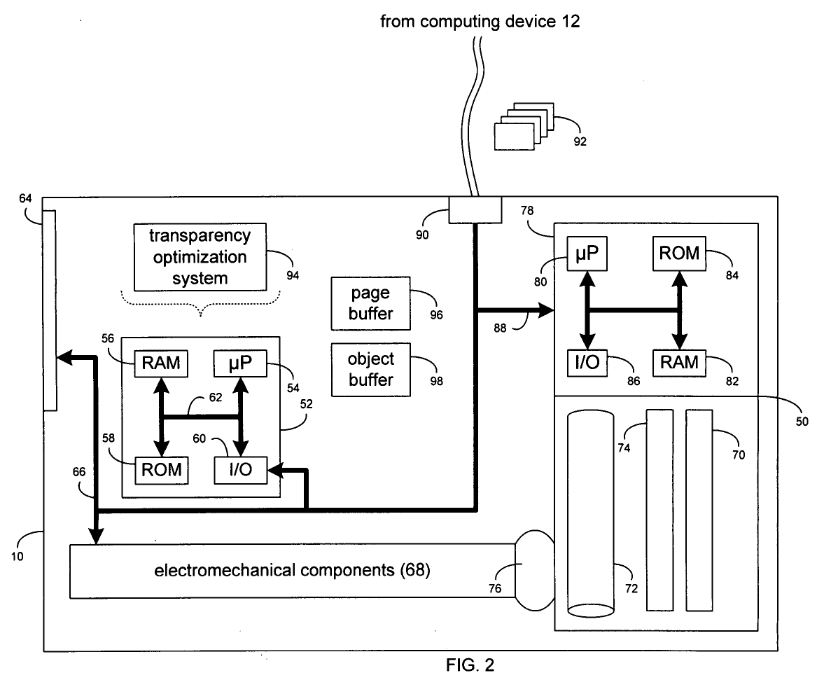

Referring also to FIG. 2, printing device 10 may include a printer cartridge 50 for use within printing device 10. Printer cartridge 50 may be a component of printing device 10, which typically includes the consumables/wear components (e.g. toner, a drum assembly, and a fuser assembly, for example) of printing device 10. Printer cartridge 50 may also include circuitry and electronics (not shown) required to e.g., charge the drum and control the operation of printer cartridge 50.

Printing device 10 may include a system board 52 for controlling the operation of printing device 10. System board 52 may include a microprocessor 54, random access memory (i.e., RAM) 56, read only memory (i.e., ROM) 58, and an input/output (i.e., I/O) controller 60. Microprocessor 54, RAM 56, ROM 58, and I/O controller 60 may be coupled to each other via data bus 62. Examples of data bus 62 may include a PCI (i.e., Peripheral Component Interconnect) bus, an ISA (i.e., Industry Standard Architecture) bus, or a proprietary bus, for example.

Printing device 10 may include display panel 64 for providing information to or receiving information from a user (not shown). Display panel 64 may include e.g. an LCD (i.e. liquid crystal display) panel, one or more LEDs (i.e., light emitting diodes), and one or more switches. Display panel 64 may be coupled to I/O controller 60 of system board 52 via data bus 66. Examples of data bus 66 may include a PCI (i.e., Peripheral Component Interconnect) bus, an ISA (i.e., Industry Standard Architecture) bus, or a proprietary bus, for example. Printing device 10 may also include electromechanical components 68, such as: feed motors (not shown), gear drive assemblies (not shown), paper jam sensors (not shown), and paper feed guides (not shown), for example. Electromechanical components 68 may be coupled to system board 52 via data bus 66 and I/O controller 60.

As discussed above, printer cartridge 50 may include a toner reservoir 70, toner drum assembly 72, and fuser assembly 74, for example. Electromechanical components 68 may be mechanically coupled to printer cartridge 50 via a releasable gear assembly 76 that allows printer cartridge 50 to be removed from printing device 10.

Printer cartridge 50 may include a system board 78 that controls the operation of printer cartridge 50. System board 78 may include microprocessor 80, RAM 82, ROM 84, and I/O controller 86, for example. System board 78 may be releasably coupled to system board 52 via data bus 88, thus allowing for the removal of printer cartridge 50 from printing device 10. Examples of data bus 88 may include a PCI (i.e., Peripheral Component Interconnect) bus, an ISA (i.e., Industry Standard Architecture) bus, an I2C (i.e., Inter-IC) bus, an SPI (i.e., Serial Peripheral Interconnect) bus, or a proprietary bus.

Printing device 10 may include one or more input ports 90 coupled to e.g., I/O controller 60 of system board 52. Input port 90 may be e.g., a parallel printer port, a USB (i.e., universal serial bus) port and/or a network interface port (i.e., for allowing printing device 10 to function as a network device within computer network 18). Printing device 10 may receive print jobs 92, via input port 90, from computing device 12. As discussed above, print job 92 may define a plurality of objects to be rendered on the various pages of the print job. One or more of these objects may overlap with other objects on the same page of the print job, and the overlapping objects may be made transparent so that the overlapped object is viewable beneath the overlapping object.

Various types of objects may be included within print job 92, such as: image objects (e.g., a photograph), text objects (e.g., the letter “M”), and fill objects (e.g., a crosshatch pattern for use as a background within a square).

Printing device 10 may execute a transparency optimization system 94 that processes received print jobs (e.g., print job 92) to improve efficiency when rendering transparent objects.

The instruction sets and subroutines of transparency optimization system 94, which are typically stored on a storage device (e.g., ROM 58), may be executed by one or more processors (e.g., processor 54) and one or more memory architectures (e.g., RAM 56) incorporated into printing device 10. While the storage device is shown to be ROM 58, other configurations are possible. For example, the storage device may be, for example, a hard disk drive, a tape drive, an optical drive, a RAID array, and/or random access memory (RAM). Transparency optimization system 94 will be discussed below in greater detail.

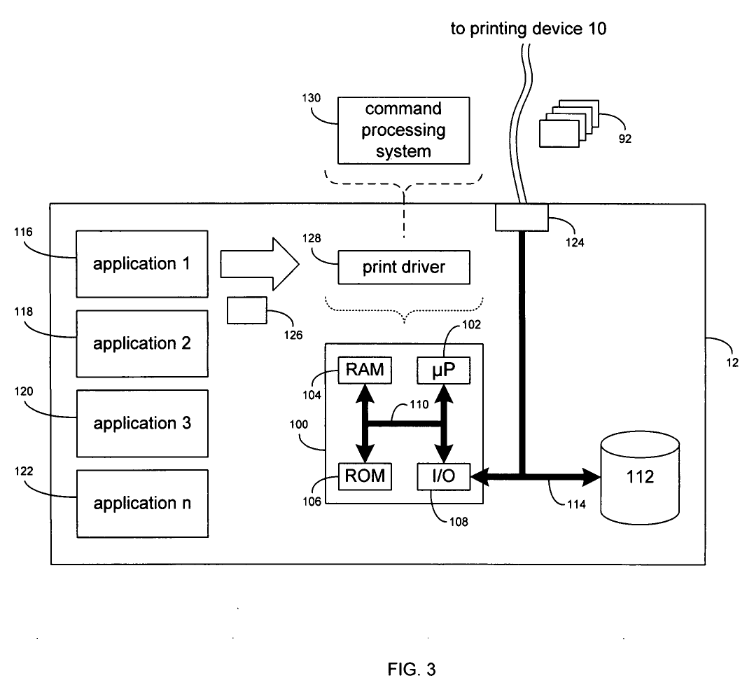

Referring to FIG. 3, computing device 12 may include a system board 100 for controlling the operation of computing device 12. System board 100 may include a microprocessor 102, random access memory (i.e., RAM) 104, read only memory (i.e., ROM) 106, and an input/output (i.e., I/O) controller 108. Microprocessor 102, RAM 104, ROM 106, and I/O controller 108 may be coupled to each other via data bus 110. Examples of data bus 110 may include a PCI (i.e., Peripheral Component Interconnect) bus, or an ISA (i.e., Industry Standard Architecture) bus, for example.

Computing device 12 may include a storage device 112 coupled to system board 100 via data bus 114. Examples of storage device 112 include a hard disk drive and an optical drive, for example. Examples of data bus 114 include SCSI (i.e., Small Computer System Interface), IDE (i.e., Integrated Drive Electronics), EIDE (i.e., Enhanced Integrated Drive Electronics), ATA (i.e., Advanced Technology Attachment), SATA (i.e., Serial Advanced Technology Attachment).

Microprocessor 102 of computing device 10 may execute one or more software applications (e.g., applications 116, 118, 120, 122). Examples of applications 116, 118, 120, 122 include Microsoft™ Word™, Excel™, Powerpoint™ and Visio™. During execution of applications 116, 118, 120, 122, a user (not shown) may issue one or more print requests, resulting in the generation of print job 92 which is provided to printing device 10 via data port 124. Examples of data port 124 include a USB (i.e., universal serial bus) port, a parallel printer port and/or an Ethernet port (i.e., when print job 92 is delivered to printing device 10 via a computing network). Once a user (not shown) issues a print request, the application receiving the request from the user may generate one or more print commands 126 that are provided to print driver 128. Examples of print commands 126 may include GDI (i.e., graphical device interface) commands for rendering an image, for example. Print driver 128 may receive print commands 126 and converts print commands 126 into a language that is processable by printing device 10. For example, if print driver 128 is a postscript print driver, print driver 128 may convert print commands 126 (i.e., GDI commands) into postscript commands that may be provided to printing device 10 as print job 92.

However, all print commands provided to print driver 128 may not need to be converted by print driver 128 into another format (e.g., postscript commands). For example, print commands 126 may include one or more pass-through commands, which are typically not processed by print driver 128 and are merely passed-through to printing device 10 in their unmodified state. An example of such a pass-though command is a GDI escape sequence. These pass-through commands may already be in the format expected by the printing device that will receive the print job. For example, if application 116 is capable of generating print commands that are in e.g., postscript format, these print commands may be provided to print driver 128 as pass-through commands, as they do not need to be converted (into postscript commands) prior to being provided to printing device 10.

Unfortunately, as pass-through commands are not processed by print driver 128 prior to being provided to computing device 10, any inefficiencies of the pass-through command may result in inefficient operation of printing device 10.

Print driver 128 may execute a command processing system 130 that processes print commands (e.g., print commands 126) received by print driver 128 and marks certain pass-through commands for subsequent processing by transparency optimization system 94 (FIG. 2).

The instruction sets and subroutines of command processing system 130, which are typically stored on storage device 112, may be executed by one or more processors (e.g., processor 102) and one or more memory architectures (e.g., RAM 104) incorporated into computing device 12. Alternatively, the instruction sets and subroutines of command processing system 130 may be stored on e.g., a tape drive, a RAID array, RAM 104 and/or ROM 106. Command processing system 130 will be discussed below in greater detail.

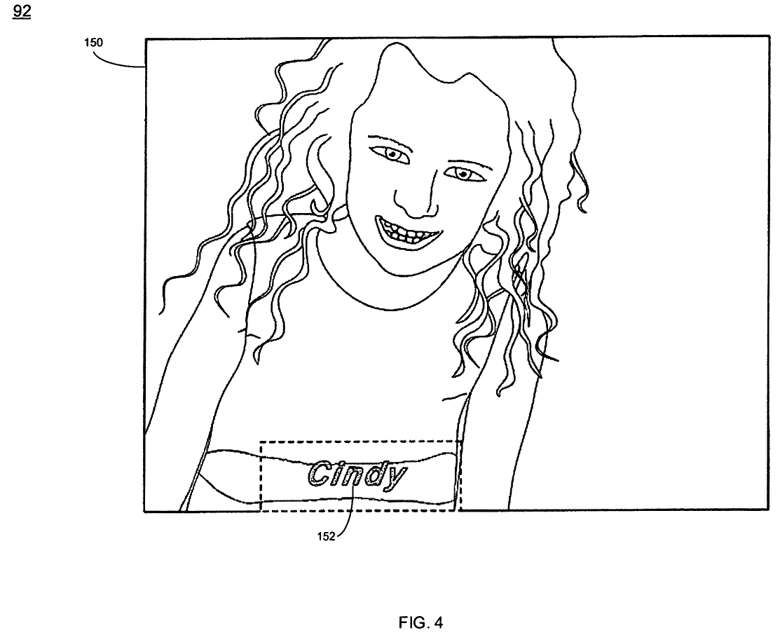

As discussed above, an overlapping object may be made transparent so that the overlapped object is viewable through the overlapping object. Referring also to FIG. 4, assume that print job 92 includes object 150 (e.g., a photographic image) that is overlapped by object 152 (e.g., a text-based title). Object 152 (i.e., the word “Cindy”) may be made transparent to allow object 150 (i.e., a photograph of “Cindy”) to be partially visible through object 152.

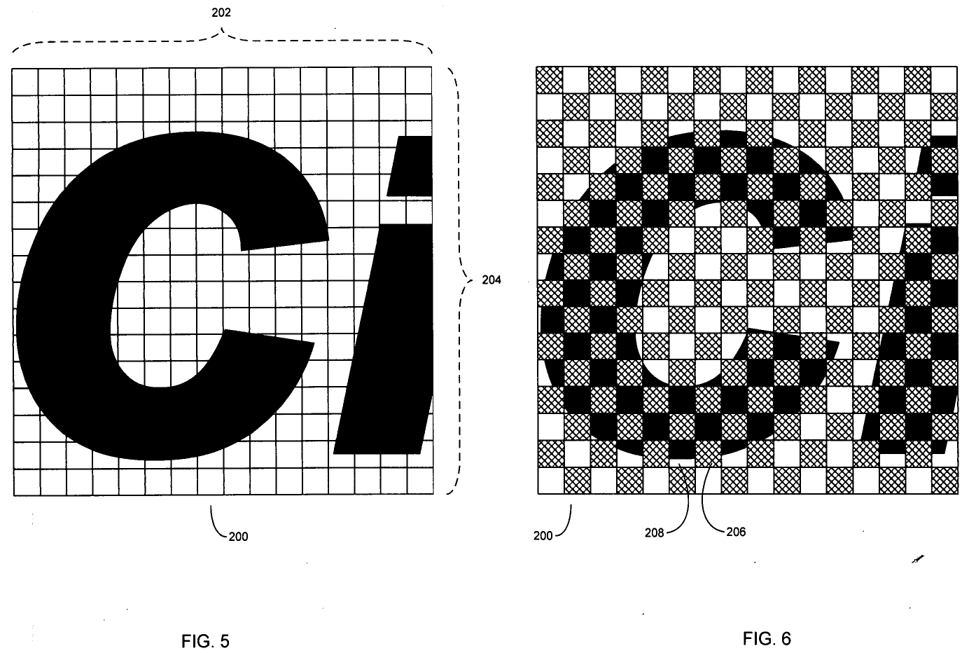

Referring also to FIGS. 5 & 6, during a traditional transparency process, when an object is to be made transparent, an image mask 200 is typically applied to the object to be made transparent. For example, when rendering print job 92, printing device 10 may apply image mask 200 to object 152 (i.e., the word “Cindy”). Image mask 200 may be a grid, such that each cell of the grid represents one PEL (i.e., pixel element) of printer resolution to be rendered onto the sheet of media. For illustrative purposes, image mask 200 is shown to be a 16×16 PEL grid, which includes sixteen one-PEL wide columns 202 and sixteen one-PEL wide rows 204.

When applying image mask 200 (and as will be discussed below in greater detail), the individual PELs within the mask may be configured as “render” PELs or as “do not render” PELs. For example, image mask 200 may be configured as a checkerboard mask, in that the PELs within mask 200 alternate (between “render” PELs and “do not render” PELs) as you move from column to column, and from row to row. For illustrative purposes, “do not render” PELs (e.g., PEL 206) are illustrated to include a crosshatch pattern and “render” PELs (e.g., PEL 208) are illustrated to allow portions of the letter “C” (i.e., object 152) to be visible through image mask 200. Accordingly, when applying image mask 200, only every other PEL of e.g., the letter “C” is rendered. Accordingly, a letter “C” is generated that is 50% transparent, as the object that is overlapped by the letter “C” (i.e., the photograph of “Cindy”) is visible through the “do not render” PELs.

The percentage of transparency of an object may be varied by adjusting the ratio of “render” PELs to “do not render” PELs. For example, if all PELs within mask 200 are “render” PELs, the letter “C” is 0% transparent (i.e., the object positioned behind the letter “C” will not be visible and only the letter “C” will be visible). Alternatively, if all PELs within mask 200 are “do not render” PELs, the letter “C” is 100% transparent (i.e., the letter “C” will not be visible and only the object behind the letter “C” will be visible).

Continuing with the above-stated example, when rendering object 152 (i.e., the word “Cindy”) on top of object 150 (i.e., the photograph of “Cindy”), object 150 is rendered to page buffer 96 (FIG. 2) and object 152 is rendered to object buffer 98 (FIG. 2). Rendering is the process of converting the objects received by printing device 10 into the various PELs that comprise the printed image produced by printing device 10. A buffer is a temporary storage area in which e.g., objects are stored by a first device/process so that they can subsequently be retrieved by a second device/process. For example, rendering circuitry within printing device 10 may store rendered objects within a buffer so that circuitry within printing device 10 that applies the rendered objects to drum assembly 72 may subsequently retrieve the rendered objects for processing.

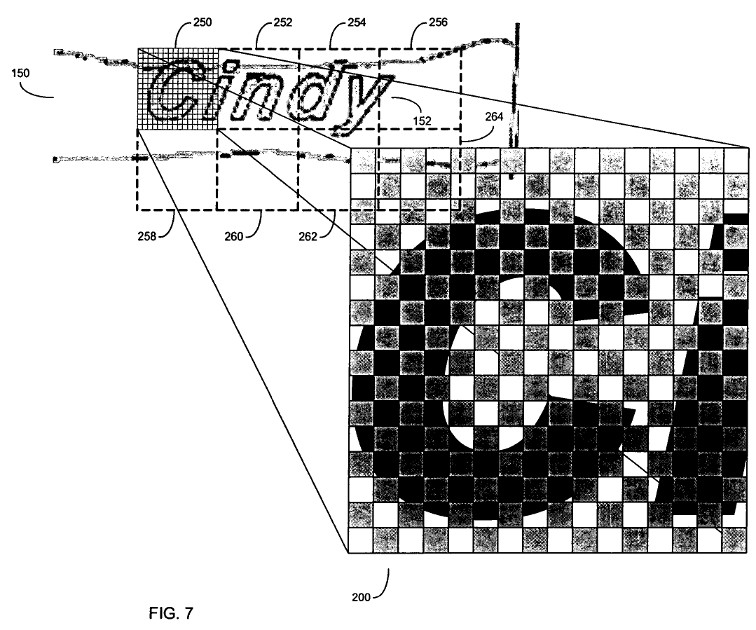

During a traditional transparency process, when applying a mask to an object to be made transparent, the decision concerning whether to render a particular pixel of the object may be determined by the status of the corresponding image mask PEL. Referring also to FIG. 7, once object 150 is rendered to page buffer 96 and object 152 is rendered to object buffer 98, image mask 200 may be applied to a first portion (e.g., portion 250) of object 152 (as stored in object buffer 98). Printing device 10 may then render (onto object 150 stored within page buffer 96) the portions of object 152 visible through image mask 200. In other words, the portions of object 152 positioned within the “render” PELs of image mask 200 may be rendered onto image 150 (which is stored within page buffer 96). Conversely, the portions of image 152 that are not visible through image mask 200 may not be rendered onto object 150. In other words, the portions of object 152 positioned within “do not render” PELs of image mask 200 may not be rendered onto image 150 (which is stored within page buffer 96). In this example, image mask 200 may be a 16×16 PEL grid. Accordingly, image mask 200 may include 256 PELs, of which 128 are “render” PELs and 128 are “do not render” PELs). Therefore, 128 PELs of image 152 (which is stored in object buffer 98) may be rendered onto image 150 (which is stored in page buffer 96).

During a traditional transparency process, once portion 250 of object 152 is completely processed (i.e., all 128 “render” PELs are rendered onto image 150), object 152 is re-rendered within object buffer 98 (or a different object buffer; not shown). Further, the content of page buffer 96 may be maintained, which (continuing with the above-stated example) contains a rendered version of object image 150. However, a first portion 250 of rendered object 150 has been modified to include 128 PELs of object 152 (i.e., the word “Cindy”), while the remaining one-hundred-twenty-eight PELs of first portion 250 are PELs of object 150 (i.e., the picture of “Cindy”). Accordingly, 50% of portion 250 comprises PELs of object 150 and 50% of portion 250 comprises PELs of object 152. Therefore, concerning portion 250, object 152 may appear 50% transparent, in that 50% of object 150 is viewable through object 152.

As discussed above, during a traditional transparency process, once portion 250 is completely processed, object 152 is re-rendered within object buffer 98 (or another object buffer; not shown). Image mask 200 may then be repositioned to a different portion (e.g., portion 252) of object 152 and the above-described process of rendering the “render” PELs (of image mask 200) onto object 150 (which is stored in page buffer 96) may be repeated. This processes of re-rendering object 152 within object buffer 98 and repositioning image mask 200 may be continued until the entire area of object 152 has been processed. For example, image mask 200 may be repositioned to cover eight distinct portions (namely portions 250, 252, 254, 256, 258, 260, 262, 264), thus resulting in object 152 being rendered eight times. Accordingly, during a traditional transparency process, the repetitive rendering of object 152 may consume a considerable amount of processing power and, therefore, may reduce the efficiency of printing device 10.

As a further example, assume that object 152 is a full page of text (as opposed to the word “Cindy”) and assume that printing device 10 is a 1,200 PEL per inch printing device. Further, assume that object 152 (i.e., the full page of text) is 7.5 inches wide and 10.5 inches high. Accordingly, object 152 is 9,000 PELs wide and 12,600 PELs high. As image mask 200 (in this example) is a 16×16 PEL image mask, when repositioning image mask 200 to cover all of object 152, 563 columns of image mask 200 (i.e., for a total of 9,008 PELs) would be required to fully-process object 152. Further, 788 rows of image mask 200 (i.e., for a total of 12,608 PELs) would be required to fully-process object 152. Accordingly, in this example, object 152 would be divided into 443,644 portions. Therefore, during a traditional transparency process, object 152 would need to be rendered 443,644 times to make object 152 transparent with respect to object 150.

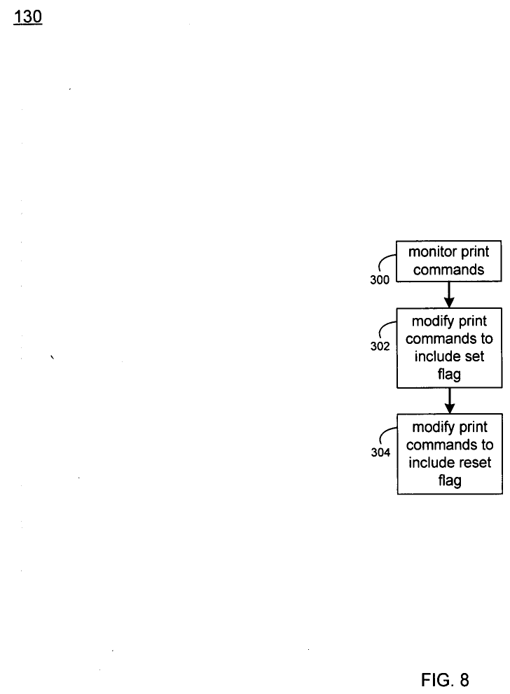

Referring also to FIG. 8, in order to reduce the occurrence of such repetitive rendering of e.g., object 152, command processing system 130 (as shown in FIG. 3) may monitor 300 print commands (e.g., print commands 126, FIG. 3) that are received by print driver 128 to identify suspect commands, which are indicative of the repetitive rendering process described above (e.g., the repetitive rendering of object 152). Examples of such suspect commands are GDI escape sequences that begin with: “userdict/GpPBeg”, “0 GpPBeg” “/languagelevel”, or “GpPBeg1” and end with “ds imagemask grestore} for pop} forGSE”.

In the event that command processing system 130 identifies such a suspect command, command processing system 130 may modify 302 the suspect command to include a set flag positioned proximate a beginning portion of the suspect command. An example of such a set flag is:
1183615869 internaldict/SetSpecialImagemaskFlag known {1183615869 internaldict/SetSpecialImagemaskFlag get 1 exch exec}if

Command processing system 130 may further modify 304 the suspect command to include a reset flag positioned proximate an ending portion of the suspect command. An example of such a reset flag is:
1183615869 internaldict/SetSpecialImagemaskFlag known {1183615869 internaldict/SetSpecialImagemaskFlag get 0 exch exec}if

As the above-described suspect commands are GDI escape sequences, the suspect commands are pass-through commands that are not typically processed by print driver 128 prior to being provided to printing device 10. Accordingly, once a suspect command is modified 300, 302 to include set and reset flags (respectively), processing of the suspect command is complete and the modified suspect command may be provided to printing device 10.

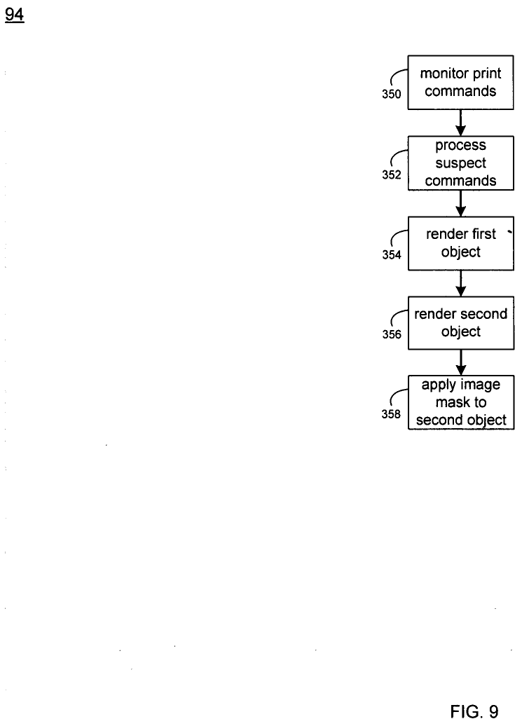

Referring also to FIG. 9, transparency optimization system 94 (as shown in FIG. 2) may monitor 350 print commands received from computing device 10 and included within print job 92 to identify suspect commands. As discussed above, suspect commands may be modified by command processing system 130 to include set and reset flags.

When transparency optimization system 94 identifies a suspect command, transparency optimization system 94 may process 352 the suspect command to extract the image mask (e.g., image mask 200). As discussed above, an image mask may be a PEL grid that is used to render a first object transparent with respect to a second object. In addition to image mask 200, the suspect command may include one or more of the objects to be processed. For example, the suspect command provided to printing device 10 may include e.g., object 150 and/or object 152. Accordingly, transparency optimization system 94 may process 352 the suspect command to extract object 150 and/or object 152.

Typically, a suspect command received by printing device 10 (which, if executed, would result in the repetitive rendering process described above) may include a plurality of nested loops. For example, a suspect command may be configured to first render object 150 (i.e., the photograph of “Cindy”) into page buffer 96. The suspect command may then render object 152 (i.e., the word “Cindy”) into object buffer 98. Image mask 200 may then be sequentially applied to portions 250, 252, 254, 256 (along the x-axis) until the top row of object 152 is processed. As discussed above, prior to applying image mask 200 to each of portions 250, 252, 254, 256, the suspect command would render object 152 into object buffer 98. Once the first row of object 152 is fully processed, image mask 200 may be displaced along the y-axis (i.e., into portion 258) and sequentially applied to portions 258, 260, 262, 264 (along the x-axis) until the bottom row of object 152 is processed. Again and as discussed above, prior to applying image mask 200 to each of portions 258, 260, 262, 264, the suspect command would render object 152 into object buffer 98.

In order to avoid such repetitive rendering, transparency optimization system 94 may process 352 the suspect command to extract the image mask (e.g., image mask 200) and (if included within the suspect command) object 150 and/or object 152. If the suspect command includes one or more nested loops, transparency optimization system 94 may process 352 as many loops as required to obtain image mask 200 and object 150 and/or object 152 (if included within the suspect command). Alternatively, object 150 and/or object 152 may be included within and obtained from another portion of print job 92.

Once image mask 200, object 150, and object 152 are obtained by transparency optimization system 94, transparency optimization system 94 may render 354 object 152 (i.e., the word “Cindy”) to object buffer 98. Additionally, transparency optimization system 94 may render 356 object 150 (i.e., the picture of “Cindy”) to page buffer 96. Transparency optimization system 94 may then apply 358 image mask 200 to various portions of object 152.

Referring again to FIG. 7, when transparency optimization system 94 applies image mask 200 to object 152, transparency optimization system 94 may render (onto object 150 stored within page buffer 96) the portions of object 152 that are positioned within the “render” PELs of image mask 200. Conversely, the portions of object 152 that are within the “do not render” PELs of image mask 200 may not be rendered onto object 150 (which is stored within page buffer 96).

Once portion 250 of object 152 is completely processed (i.e., all 128 “render” PELs are rendered onto image 150), image mask 200 may be repositioned to a different portion (e.g., portion 252) of object 152 and the above-described process of rendering the “render” PELs (of image mask 200) onto object 150 (which is stored in page buffer 96) may be repeated. As discussed above, the content of page buffer 96 may be maintained, which contains a rendered version of object image 150.

This process of repositioning image mask 200 may be continued until the entire area of object 152 has been processed and the various portions of object 152 (as governed by image mask 200) are applied to object 150. However, unlike the repetitive rendering process (discussed above) that would have been carried out by the suspect command, transparency optimization system 94 does not repeatedly render object 152 (into object buffer 98) each time that image mask 200 is repositioned. Accordingly, even though object 152 (i.e., the word “Cindy”) is divided into eight portions (namely portions 250, 252, 254, 256, 258, 260, 262, 264), object 152 may only be rendered once.

Further, for the example discussed above in which object 152 is a full page of text, even though object 152 is divided into 443,644 portions, transparency optimization system 94 may only render object 152 once.

While transparency optimization system 94 is described above as only rendering object 152 (i.e., the object to be made transparent) once, other configurations are possible. For example, transparency optimization system 94 may repeatedly render object 152 and still be more efficient than the suspect command. For example, if the suspect command had been executed, object 152 would have been rendered eight times (i.e., once for each of portions 250, 252, 254, 256, 258, 260, 262, 264). Therefore, transparency optimization system 10 may be configured to render object 152 once for each two portions processed by image mask 200. Accordingly, when processing object 152 (which includes portions 250, 252, 254, 256, 258, 260, 262, 264), object 152 may be rendered a total of four time (i.e., 50% less times than it would have been rendered by the suspect command).

A number of implementations have been described. Nevertheless, it will be understood that various modifications may be made. Accordingly, other implementations are within the scope of the following claims.

What is claimed is:

1. A method comprising:
monitoring one or more print commands received by a print driver to identify a suspect command, wherein the suspect command is indicative of a repetitive rendering process; and
modifying the suspect command to include a set flag proximate a beginning portion of the suspect command.

2. The method of claim 1 further comprising:
modifying the suspect command to include a reset flag proximate an ending portion of the suspect command.

3. The method of claim 1 wherein the repetitive rendering process is configured to render a first object on top of a second object, wherein the first object is a transparent object.

4. The method of claim 3 wherein the suspect command includes the first object and an image mask.

5. The method of claim 4 wherein the image mask is indicative of a level of transparency of the first object.

6. The method of claim 4 wherein the image mask is a checkerboard mask.

7. The method of claim 4 wherein:
the image mask has a defined x-axis dimension and a defined y-axis dimension;
the first object has a defined x-axis dimension and a defined y-axis dimension; and
at least one of the x-axis and y-axis dimensions of the image mask is less than at least one of the x-axis and y-axis dimensions of the first object.

8. The method of claim 7 wherein the repetitive rendering process is further configured to:
apply the image mask to a plurality of unique portions of the first object; and
render the first object prior to each application of the image mask.

9. The method of claim 1 wherein the suspect command is a GDI (graphical device interface) escape sequence.

10. A computer program product residing on a computer readable medium having a plurality of instructions stored thereon which, when executed by a processor, cause the processor to:
monitor one or more print commands received by a print driver to identify a suspect command, wherein the suspect command is indicative of a repetitive rendering process; and
modify the suspect command to include a set flag proximate a beginning portion of the suspect command.

11. The computer program product of claim 10 further comprising instructions for:
modifying the suspect command to include a reset flag proximate an ending portion of the suspect command.

12. The computer program product of claim 10 wherein the repetitive rendering process is configured to render a first object on top of a second object, wherein the first object is a transparent object.

13. The computer program product of claim 12 wherein the suspect command includes the first object and an image mask.

14. The computer program product of claim 13 wherein the image mask is indicative of a level of transparency of the first object.

15. The computer program product of claim 13 wherein the image mask is a checkerboard mask.

16. The computer program product of claim 13 wherein:
the image mask has a defined x-axis dimension and a defined y-axis dimension;
the first object has a defined x-axis dimension and a defined y-axis dimension; and
at least one of the x-axis and y-axis dimensions of the image mask is less than at least one of the x-axis and y-axis dimensions of the first object.

17. The computer program product of claim 16 wherein the repetitive rendering process is further configured to:
apply the image mask to a plurality of unique portions of the first object; and
render the first object prior to each application of the image mask.

18. The computer program product of claim 10 wherein the suspect command is a GDI (graphical device interface) escape sequence.

19. A method comprising:
monitoring one or more print commands received from a print driver to identify a suspect command;
processing the suspect command to extract an image mask and a first object, wherein the first object is a transparent object;
rendering the first object to generate a rendered first object; and
applying the image mask to at least two unique portions of the rendered first object.

20. The method of claim 19 wherein the suspect command includes a set flag proximate a beginning portion of the suspect command.

21. The method of claim 19 wherein the suspect command includes a reset flag proximate an ending portion of the suspect command.

22. The method of claim 19 wherein:
the image mask has a defined x-axis dimension and a defined y-axis dimension;
the first object has a defined x-axis dimension and a defined y-axis dimension; and
at least one of the x-axis and y-axis dimensions of the image mask is less than at least one of the x-axis and y-axis dimensions of the first object.

23. The method of claim 19 wherein:
the rendered first object includes a plurality of unique portions; and
applying the image mask to at least two unique portions of the rendered first object includes applying the image mask to each of the plurality of unique portions of the rendered first object.

24. The method of claim 19 wherein the suspect command is a GDI (graphical device interface) escape sequence.

25. The method of claim 19 further comprising:
rendering a second object, wherein rendering the first object includes rendering the first object on top of the second object.

26. The method of claim 19 wherein:
the first object is a transparent object; and
the image mask is indicative of a level of transparency of the first object.

27. The method of claim 19 wherein the image mask is a checkerboard mask.

28. A computer program product residing on a computer readable medium having a plurality of instructions stored thereon which, when executed by a processor, cause the processor to:
monitor one or more print commands received from a print driver to identify a suspect command;
process the suspect command to extract an image mask and a first object, wherein the first object is a transparent object;
render the first object to generate a rendered first object; and
apply the image mask to at least two unique portions of the rendered first object.

29. The computer program product of claim 28 wherein the suspect command includes a set flag proximate a beginning portion of the suspect command.

30. The computer program product of claim 28 wherein the suspect command includes a reset flag proximate an ending portion of the suspect command.

31. The computer program product of claim 28 wherein:
the image mask has a defined x-axis dimension and a defined y-axis dimension;
the first object has a defined x-axis dimension and a defined y-axis dimension; and
at least one of the x-axis and y-axis dimensions of the image mask is less than at least one of the x-axis and y-axis dimensions of the first object.

32. The computer program product of claim 28 wherein:
the rendered first object includes a plurality of unique portions; and
applying the image mask to at least two unique portions of the rendered first object includes applying the image mask to each of the plurality of unique portions of the rendered first object.

33. The computer program product of claim 28 wherein the suspect command is a GDI (graphical device interface) escape sequence.

34. The computer program product of claim 28 further comprising instructions for:
rendering a second object, wherein rendering the first object includes rendering the first object on top of the second object.

35. The computer program product of claim 28 wherein:
the first object is a transparent object; and
the image mask is indicative of a level of transparency of the first object.

36. The computer program product of claim 28 wherein the image mask is a checkerboard mask.

37. A printing device configured for:
monitoring one or more print commands received from a print driver to identify a suspect command;
processing the suspect command to extract an image mask and a first object, wherein the first object is a transparent object;
rendering the first object to generate a rendered first object; and
applying the image mask to at least two unique portions of the rendered first object.

38. The printing device of claim 37 wherein the suspect command includes a set flag proximate a beginning portion of the suspect command.

39. The printing device of claim 37 wherein the suspect command includes a reset flag proximate an ending portion of the suspect command.

40. The printing device of claim 37 wherein:
the image mask has a defined x-axis dimension and a defined y-axis dimension;
the first object has a defined x-axis dimension and a defined y-axis dimension; and
at least one of the x-axis and y-axis dimensions of the image mask is less than at least one of the x-axis and y-axis dimensions of the first object.

41. The printing device of claim 37 wherein:
the rendered first object includes a plurality of unique portions; and
applying the image mask to at least two unique portions of the rendered first object includes applying the image mask to each of the plurality of unique portions of the rendered first object.

42. The printing device of claim 37 wherein the suspect command is a GDI (graphical device interface) escape sequence.

43. The printing device of claim 37, wherein the printing device is further configured for:
rendering a second object, wherein rendering the first object includes rendering the first object on top of the second object.

44. The printing device of claim 37 wherein:
the first object is a transparent object; and
the image mask is indicative of a level of transparency of the first object.

45. The printing device of claim 37 wherein the image mask is a checkerboard mask.
